(19) United States
(12) Patent Application Publication
(10) Pub. No.: US 2022/0306515 A1
(43) Pub. Date: Sep. 29, 2022

(54) METHOD FOR MANUFACTURING OPTICAL FIBER PREFORM AND APPARATUS FOR MANUFACTURING OPTICAL FIBER PREFORM

(71) Applicant: SUMITOMO ELECTRIC INDUSTRIES, LTD., Osaka (JP)

(72) Inventors: Takahiro SAITO, Osaka (JP); Sotaro IDA, Osaka (JP); Hiroki INOUE, Osaka (JP)

(73) Assignee: SUMITOMO ELECTRIC INDUSTRIES, LTD., Osaka (JP)

(21) Appl. No.: 17/697,124

(22) Filed: Mar. 17, 2022

(30) Foreign Application Priority Data
Mar. 24, 2021 (JP) 2021-050119

(51) Int. Cl. C03B 37/014

(52) U.S. Cl. CPC C03B 37/0142; C03B 2207/22

(57) ABSTRACT

A method for manufacturing an optical fiber preform includes a deposition step and an introduction step. In the deposition step, glass fine particles are generated from a glass raw material gas in a flame obtained by burning a flammable gas supplied to a burner, and the glass fine particles are deposited to produce a hollow porous glass preform. In the introduction step, a first gas is introduced into an inside of a hollow of the porous glass preform, and a second gas is introduced to an outside of the porous glass preform. In the method, at least one of the first gas and the second gas is a gas containing halogen. In the gas introduction step, the gas containing halogen is introduced so that a first partial pressure of the first gas and a second partial pressure of the second gas are different from each other.

### CROSS-REFERENCE TO RELATED APPLICATION

This application is based upon and claims the benefit of priority from Japanese Patent Application No. 2021-050119, filed on Mar. 24, 2021, the entire contents of which are incorporated herein by reference.

### TECHNICAL FIELD

The present disclosure relates to a method for manufacturing an optical fiber preform and an apparatus for manufacturing an optical fiber preform.

### BACKGROUND

US2019/0369325 A1 discloses a method for manufacturing an optical fiber preform having a core portion that contains a high concentration of chlorine and a cladding portion that surrounds the core portion. In this method, to realize an addition of a high concentration of chlorine to the core portion, the core portion is exposed to chlorine exceeding 1 atm. US2019/0119143A1 discloses a method of adding a high concentration of chlorine to a soot body of an optical fiber. In a step of causing transparent vitrification of the soot body of the optical fiber in this method, a concentration of chlorine taken into the glass is increased by increasing a partial pressure of silicon tetrachloride used in a doping step.

### SUMMARY

The present disclosure provides a method for manufacturing an optical fiber preform. The method includes a glass fine particle deposition step and a gas introduction step. In the glass fine particle deposition step, glass fine particles are generated from a glass raw material gas in a flame obtained by burning a flammable gas supplied to a burner, and the glass fine particles are deposited to produce a hollow porous glass preform. In the gas introduction step, a first gas is introduced into an inside of a hollow of the porous glass preform, and a second gas is introduced to an outside of the porous glass preform. In the method, at least one of the first gas and the second gas is a gas containing halogen. In the gas introduction step, the gas containing halogen is introduced so that a first partial pressure of the first gas and a second partial pressure of the second gas are different from each other.

The present disclosure provides an apparatus for manufacturing an optical fiber preform. The apparatus includes a furnace tube, a heater, and a gas introduction device. The furnace tube is configured to accommodate a hollow porous glass preform. The heater heats the porous glass preform to cause the porous glass preform transparent vitrification. The gas introduction device introduces a first gas into an inside of a hollow of the porous glass preform and introduces a second gas to an outside of the porous glass preform. At least one of the first gas and the second gas is a gas containing halogen. The gas introduction device introduces the gas containing halogen into the furnace tube so that a first partial pressure of the first gas and a second partial pressure of the second gas are different from each other.

### BRIEF DESCRIPTION OF THE DRAWINGS

FIG. 1 is an exemplary cross-sectional view of an optical fiber preform manufactured by a method according to one embodiment.

FIG. 2A is a schematic diagram showing one step of a method for manufacturing an optical fiber preform.

FIG. 2B is a schematic diagram showing one step of a method for manufacturing an optical fiber preform.

FIG. 2C is a schematic diagram showing one step of the method for manufacturing an optical fiber preform.

FIG. 2D is a schematic diagram showing one step of the method for manufacturing an optical fiber preform.

FIG. 2E is a schematic diagram showing one step of the method for manufacturing an optical fiber preform.

FIG. 3 is a schematic diagram showing a first embodiment of a dehydration step in the method for manufacturing an optical fiber preform.

FIG. 4 is a schematic diagram showing a first embodiment of a sintering step in the method for manufacturing an optical fiber preform.

FIG. 5 is a schematic diagram showing a second embodiment of the dehydration step and the sintering step in the method for manufacturing an optical fiber preform.

FIG. 6 is a schematic diagram showing the dehydration step and the sintering step in the method for manufacturing the optical fiber preform according to the comparative example.

### DETAILED DESCRIPTION

### Problems to be Solved by the Present Disclosure

In the methods described in US2019/0369325 A1 and US2019/0119143 A1, it is necessary to increase a partial pressure of chlorine in the entire sintering furnace, which requires large-scale equipment. On the other hand, in order to make a difference in a concentration of chlorine between a core portion and a cladding portion of an optical fiber preform without using large-scale equipment, it is necessary to manufacture the core portion and the cladding portion in separate steps, which takes time and effort. Thus, it is desired to easily increase a concentration of halogen such as chlorine added to the optical fiber preform by a simple method.

### Effects of the Present Disclosure

According to the present disclosure, the concentration of halogen added to the optical fiber preform can be easily increased by a simple method.

### Explanation of Embodiment of the Present Disclosure

The contents of the embodiments of the present disclosure will be listed and described. A method for manufacturing an optical fiber preform according to an embodiment of the present disclosure includes a glass fine particle deposition step and a gas introduction step. In the glass fine particle deposition step, glass fine particles are generated from a glass raw material gas in a flame obtained by burning a flammable gas supplied to a burner, and the glass fine particles are deposited to produce a hollow porous glass preform. In the gas introduction step, a first gas is introduced into the hollow inside of the porous glass preform, and a second gas is introduced to the outside of the porous glass preform. At least one of the first gas and the second gas is a gas containing halogen. In the gas introduction step, a gas containing halogen is introduced so that a first partial pressure of the first gas and a second partial pressure of the second gas are different from each other.

In this method of manufacturing an optical fiber preform, the first gas is introduced into the hollow inside of the porous glass preform and the second gas is introduced to the outside of the porous glass preform, and at least one of the first gas and the second gas is a gas containing halogen in the gas introduction step. In the gas introduction step, the gas containing halogen is introduced so that the first partial pressure of the first gas and the second partial pressure of the second gas are different from each other. In this case, as compared with a case in which the partial pressure of the entire halogen gas to be introduced is increased, a concentration of halogen added to the optical fiber preform can be easily increased by a simple method, such as, by increasing the partial pressure of the introduced gas into a region in which halogen is desired to be added, or the like.

As one embodiment of the above-described method, the first gas may be a gas containing halogen, and the first partial pressure of the first gas may be higher than the second partial pressure of the second gas. Since halogen (for example, chlorine) is added by increasing only the partial pressure of the first gas introduced into the hollow inside of the porous glass preform, the concentration of halogen (for example, chlorine) added to the optical fiber preform can be easily increased by a simple method.

As one embodiment of the above-described method, the first gas may be a gas containing halogen, and the first partial pressure of the first gas may be 1 atm or more. Since halogen (for example, chlorine) is added by increasing only the partial pressure of the first gas introduced into the hollow inside of the porous glass preform, the concentration of halogen (for example, chlorine) added to the optical fiber preform can be easily increased by a simple method.

As one embodiment of the above-described method, the gas containing halogen may be silicon tetrachloride (SiCl₄). When the gas containing halogen is silicon tetrachloride, the concentration of chlorine added to the porous glass preform (for example, the core portion) can be easily increased as compared with a case in which chlorine gas (Cl₂) is introduced. Accordingly, for example, a refractive index of the core portion can be increased by chlorine, an amount of germanium (Ge) used for increasing the refractive index can be reduced, and Rayleigh scattering due to the added germanium can be reduced. Accordingly, it is possible to reduce a transmission loss when the porous glass preform is drawn into an optical fiber. Costs can also be reduced by reducing the amount of expensive germanium used.

As one embodiment of the above-described method, in the gas introduction step, the gas containing halogen may be introduced into at least one of the inside and the outside of the porous glass preform in an environment in which an atmospheric temperature of the porous glass preform is 1000° C. or higher and 1600° C. or lower. When the atmospheric temperature of the porous glass preform is lower than 1000° C., it is difficult to efficiently perform the addition of halogen to the porous glass preform, but it becomes possible to efficiently perform the addition of halogen by setting the temperature to 1000° C. or higher. Further, when the atmospheric temperature of the porous glass preform exceeds 1600° C., glass viscosity of the porous glass preform decreases, and the porous glass preform may be vitrified or a shape thereof may be deformed. Thus, it is possible to efficiently increase the concentration of halogen in a predetermined region by introducing the gas containing halogen in an environment in which the atmospheric temperature of the porous glass preform is 1000° C. or higher and 1600° C. or lower.

As one embodiment of the above-described method, in the glass fine particle deposition step, the porous glass preform is prepared so that an average volume density is 0.1 g/cm³ or more and 1.0 g/cm³ or less, and a circumferential barrier layer having a thickness of 10 μm or more and 1000 μm or less and a volume density of 1.5 g/cm³ or more and 2.2 g/cm³ or less may be provided at an arbitrary position in a radial direction of the porous glass preform. The first partial pressure of the first gas on the inside in the radial direction and the second partial pressure of the second gas on the outside in the radial direction can easily be made different from each other by providing the barrier layer having a high volume density, and for example, the gas containing halogen can be introduced in a state in which the partial pressure of the first gas introduced into the inside of the hollow of the porous glass preform is increased. When the average volume density of the porous glass preform is 0.1 g/cm³ or more, occurrence of soot cracks in the porous glass preform can be easily prevented. When the average volume density of the porous glass preform is 1.0 g/cm³ or less, a dehydration treatment in the dehydration step can be easily performed.

As one embodiment of the above-described method, the concentration of halogen in the gas containing halogen may be 10% by volume or more and 100% by volume or less. In this case, the concentration of halogen added to the porous glass preform can be efficiently increased.

As one embodiment of the above-described method, the partial pressure of the gas containing halogen may be 10 atm or less. In this case, a large-scale device becomes unnecessary, and the concentration of halogen added to the optical fiber preform can be easily increased by a simpler method.

An apparatus for manufacturing an optical fiber preform according to an embodiment of the present disclosure includes a furnace tube, a heater, and a gas introduction device. The furnace tube is configured to accommodate the hollow porous glass preform. The heater is configured to heat the porous glass preform. The gas introduction device is configured to introduce the first gas into the inside of the hollow of the porous glass preform and to introduce the second gas to the outside of the porous glass preform. In the manufacturing apparatus, at least one of the first gas and the second gas is a gas containing halogen. The gas introduction device introduces the gas containing halogen into the furnace tube so that the first partial pressure of the first gas and the second partial pressure of the second gas are different from each other.

In the apparatus for manufacturing an optical fiber preform, the gas introduction device introduces the first gas into the inside of the hollow of the porous glass preform and introduces the second gas to the outside of the porous glass preform, and at least one of the first gas and the second gas is the gas containing halogen. The gas containing halogen is introduced so that the first partial pressure of the first gas and the second partial pressure of the second gas are different from each other. In this case, as compared to the case in which the partial pressure of the entire halogen gas to be introduced is increased, the concentration of halogen added to the optical fiber preform can be easily increased by a simple method, by increasing the partial pressure of the introduced gas to a region in which the addition of halogen is required.

The apparatus for manufacturing the optical fiber preform according to the embodiment may further include an exhaust device that discharges the first gas introduced into the inside of the porous glass preform, and an adjustment mechanism that adjusts the partial pressure of the first gas introduced into the inside of the porous glass preform. In this case, the first partial pressure of the first gas and the second partial pressure of the second gas can be made different by a simple method due to the exhaust device and the adjustment mechanism.

In the apparatus for manufacturing the optical fiber preform according to the embodiment, the gas introduction device may introduce the gas containing halogen as the first gas into the inside of the porous glass preform so that the first partial pressure of the first gas becomes higher than the second partial pressure of the second gas. In this case, since halogen (for example, chlorine) is added by increasing only the partial pressure of the first gas introduced into the inside of the hollow of the porous glass preform, the concentration of halogen (for example, chlorine) added to the optical fiber preform can be easily increased by a simple method.

In the apparatus for manufacturing the optical fiber preform according to the embodiment, the gas containing halogen may be silicon tetrachloride (SiCl₄). When the gas containing halogen is silicon tetrachloride, the concentration of chlorine added to the porous glass preform (for example, the core portion) can be easily increased as compared with a case in which chlorine gas (Cl₂) is introduced. Thus, for example, the refractive index of the core portion can be increased by chlorine, an amount of germanium (Ge) used for increasing the refractive index can be reduced, and Rayleigh scattering due to the added germanium can be reduced. Thus, it is possible to reduce the transmission loss when the preform is drawn into an optical fiber. It is also possible to reduce costs by reducing the amount of expensive germanium used.

### Details of Embodiments of the Present Disclosure

Specific examples of a method for manufacturing an optical fiber preform and an apparatus for manufacturing an optical fiber preform according to the present disclosure will be described below with reference to the drawings. The present invention is not limited to these examples, and is indicated by the scope of claims and is intended to include all modifications within the meaning and scope equivalent to the scope of claims. In the description of the drawings, the same elements are designated by the same reference numerals, and duplicate description will be omitted.

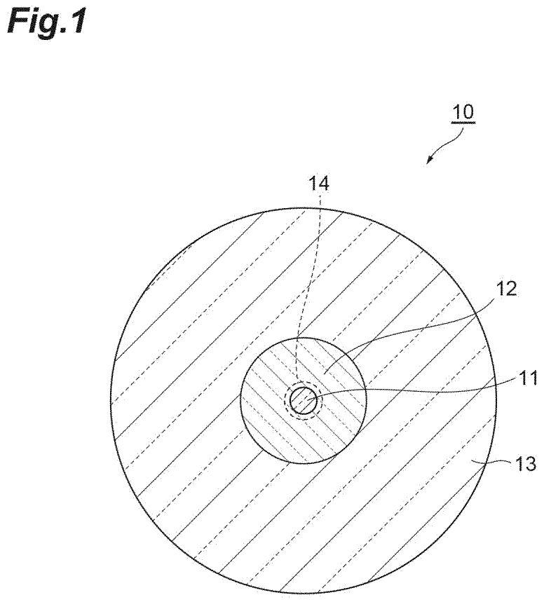

An example of an optical fiber preform manufactured by the method according to the embodiment of the present disclosure will be described with reference to FIG. 1. As shown in FIG. 1, the optical fiber preform 10 includes a core portion 11, a cladding portion 12, a jacket portion 13, and a barrier layer 14. The core portion 11 is made of, for example, silica-based glass. For example, at least one of germanium (Ge) and chlorine (Cl) is added to the core portion 11 so that a refractive index thereof is higher than that of the cladding portion 12. An alkali metal group may be added to the core portion 11. The cladding portion 12 is provided on the outside of the core portion 11 and is configured to surround the core portion 11. The jacket portion 13 is provided on the outside of the cladding portion 12 and is configured to surround the cladding portion 12. The cladding portion 12 and the jacket portion 13 are made of, for example, silica-based glass, and fluorine may be added thereto. The jacket portion 13 is a portion that functions as a second cladding portion, and is configured to have a refractive index slightly higher than that of the cladding portion 12 and lower than that of the core portion 11.

The barrier layer 14 is a layer that is provided between the core portion 11 and the cladding portion 12 and extends in a circumferential direction and an axial direction, and has a higher average volume density than that of the core portion 11 and the cladding portion 12. The barrier layer 14 is made of, for example, silica-based glass and has a refractive index equivalent to that of the cladding portion 12. The average volume density of a soot portion including the core portion 11, the cladding portion 12, and the barrier layer 14 is, for example, 0.1 g/cm³ or more and 1.0 g/cm³ or less, but the average volume density of the barrier layer 14 alone is configured to be 0.2 g/cm³ or more higher than the average volume density of the soot portion. The average volume density of the barrier layer 14 may be, for example, 1.5 g/cm³ or more and 2.2 g/cm³ or less. Further, the barrier layer 14 is configured so that a thickness in a radial direction is, for example, 10 μm or more and 1000 μm or less. The barrier layer 14 can be manufactured by adjusting a pulling speed or a rotation speed of a glass fine particle deposit at the time of sooting. A method of using the barrier layer 14 will be described later.

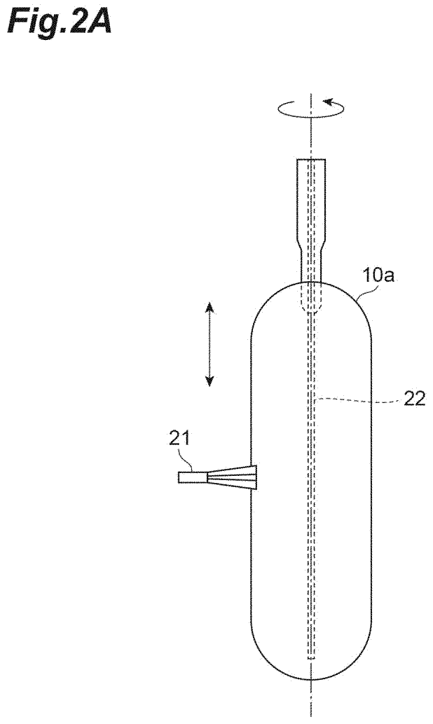

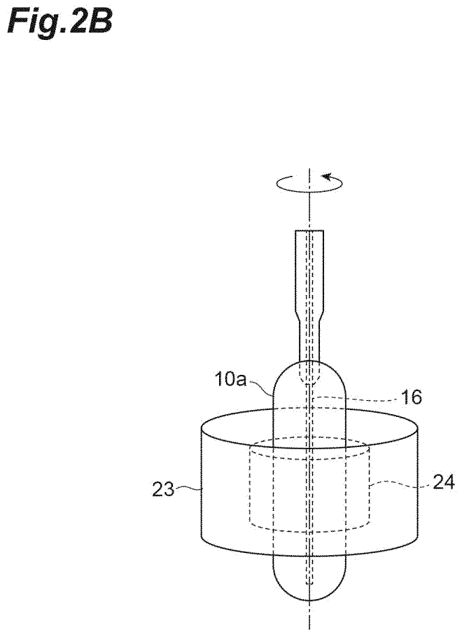

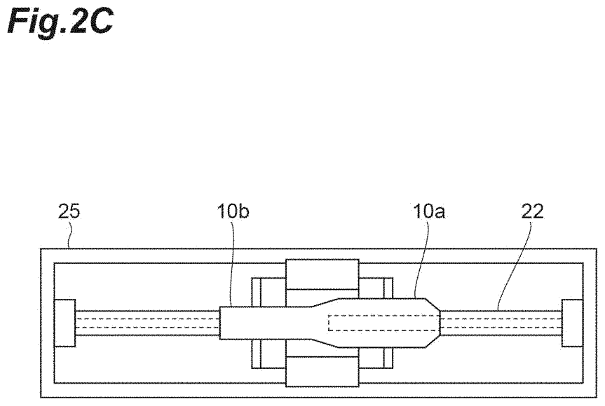

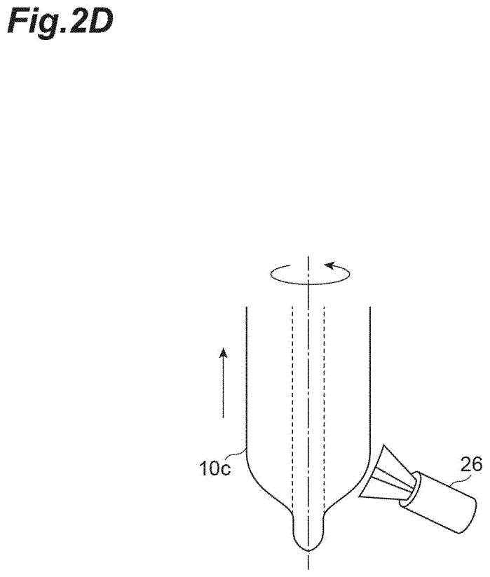

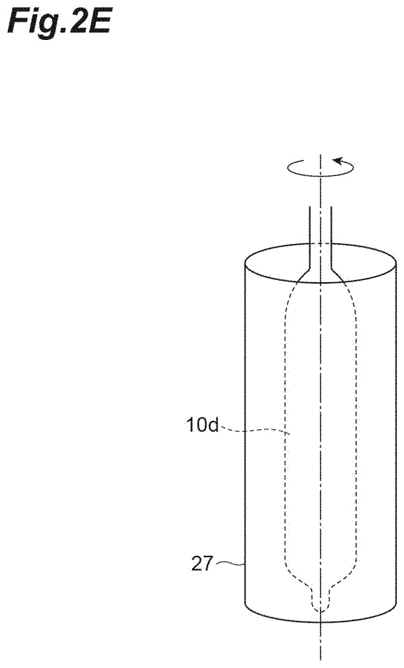

Next, a method for manufacturing the optical fiber preform 10 will be described with reference to FIGS. 2A to 2E. FIGS. 2A to 2E are schematic diagrams showing the method of manufacturing an optical fiber preform in order, and show a manufacturing method by an outside vapor deposition (OVD) method. When the optical fiber preform 10 is manufactured by the OVD method, first, as shown in FIG. 2A, a glass fine particle deposit 10a (a porous glass preform) corresponding to the core portion 11, the cladding portion 12, and the barrier layer 14 described above is produced using a burner 21 installed on the side. In this glass fine particle deposition step, the glass fine particle deposit 10a is produced by rotating and traversing a target 22 up and down while glass fine particles are deposited around the target 22 made of, for example, alumina by sooting. The burner 21 may be a single burner or may be constituted of a plurality of burners.

More specifically, glass fine particles are generated from a glass raw material gas in a flame obtained by burning a flammable gas (for example, hydrogen) supplied to the burner 21, and the glass fine particles are deposited to produce the glass fine particle deposit 10a. In addition to the flammable gas, the glass raw material gas (for example, SiCl₄ and GeCl₄) and oxygen (O₂) supplied from a gas supply system (not shown) are introduced into the burner 21. At the time of attaching core soot when the core portion 11 is formed, germanium tetrachloride (GeCl₄) is supplied from the burner 21 in addition to silicon tetrachloride (SiCl₄) and oxyhydrogen. At the time of attaching cladding soot when the cladding portion 12 is formed, the supply of germanium tetrachloride (GeCl₄) is stopped, and silicon tetrachloride and oxyhydrogen are supplied from the burner 21. If necessary, a gas (CF₄ or the like) for adding fluorine may be added from the burner 21. When the barrier layer 14 is formed, a flow rate of oxyhydrogen, a flow rate of silicon tetrachloride, or a traverse rate is adjusted so that soot having a high volume density is formed when an interface between the core and the cladding is sooted. Further, the volume density of soot may be increased by increasing a temperature of a deposited surface.

In the flame of the burner 21, glass fine particles (SiO₂) and a refractive index adjusting dopant (GeO₂) are generated by a hydrolysis reaction and a combustion reaction of the glass raw material gas shown below, and the glass fine particles generated in the flame are sprayed from the burner 21 onto the glass fine particle deposit 10a. In the manufacturing method according to the present embodiment, since high-concentration addition of chlorine or the like is performed in a subsequent dehydration step or the like, it is possible to reduce an amount of GeO₂, which is the refractive index adjusting dopant, added here.

SiCl₄+2H₂O→SiO₂+4HCl

GeCl₄+O₂→GeO₂+2Cl₂

As described above, the gases supplied from the burner 21 are different between the time of core formation and the time of cladding formation, and the types of the raw materials of the refractive index adjusting dopants contained in the glass raw material gases supplied from the burner 21 are different each other. For example, when fluorine (F) is added to the cladding portion as the refractive index adjusting dopant, the glass raw material gas contains methane tetrafluoride (CF₄) together with silicon tetrachloride. When the refractive index of the cladding portion is not adjusted, the raw material of the refractive index adjusting dopant may not be contained in the glass raw material gas. A burner for forming the core and a burner for forming the cladding may be provided separately.

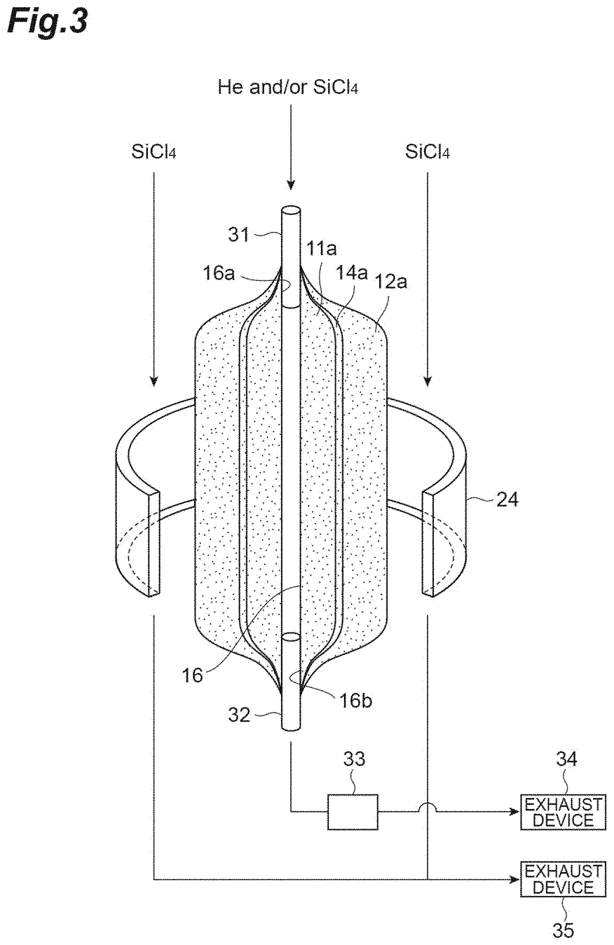

Subsequently, when the sooting is completed, as shown in FIG. 2B, after the target 22 is pulled out, the glass fine particle deposit 10a is disposed in a sintering furnace 23 (the furnace tube), and the dehydration step and the sintering step are performed using a heater 24 or the like. In the dehydration step, for example, the glass fine particle deposit 10a is heated at 1200° C. to perform a dehydration treatment, and an OH group in the glass fine particle deposit 10a is removed. In the subsequent sintering step, the temperature of the heater 24 is further raised, and the glass fine particle deposit 10a is sintered at 1500° C. to cause transparent vitrification, and a glass sintered body 10b is obtained. In both the steps, the heating due to the heater 24 is performed by moving the glass fine particle deposit 10a downward while the glass fine particle deposit 10a is rotated. During the dehydration step, the target 22 is pulled out from the glass fine particle deposit 10a, and a hollow portion 16 (refer to also FIG. 3) penetrating in the axial direction appears in the glass fine particle deposit 10a. In the dehydration step and the sintering step according to the present disclosure, a predetermined gas is introduced into the hollow portion 16 in addition to the dehydration treatment and the sintering treatment. The details of gas introduction will be described later.

Subsequently, as shown in FIG. 2C, the sintered hollow glass sintered body 10b is solidified (collapsed) in an apparatus 25 to obtain a glass sintered body 10b in which the hollow portion of the glass sintered body 10b is filled. Then, the solidified glass sintered body 10b is stretched to a desired length. Subsequently, as shown in FIG. 2D, a jacket sooting step is performed to provide the jacket portion 13 on the outer periphery of the glass sintered body 10b that has been solidified and stretched to a desired length. In the jacket sooting step, a jacket soot body is further provided on the outer periphery of a region corresponding to the cladding portion 12 of the glass sintered body 10b by a jacket burner 26, and a glass fine particle deposit 10c is produced. The jacket burner 26 has substantially the same configuration as the burner 21.

Subsequently, as shown in FIG. 2E, when the glass fine particle deposit 10c containing the jacket soot body is produced, the glass fine particle deposit 10c is disposed in a jacket sintering furnace 27. Then, the glass fine particle deposit 10c is heated to, for example, 1500° C. by a heater while it is rotated, and the glass fine particle deposit 10c is sintered to obtain a glass sintered body 10d. In this way, the optical fiber preform 10 shown in FIG. 1 is obtained. An optical fiber can be obtained from such an optical fiber preform 10 by drawing the preform using a known preform drawing apparatus. Although the example using the OVD method has been described above, the optical fiber preform 10 may be manufactured using a vapor-phase axial deposition (VAD) method or a modified chemical vaper deposition (MCVD) method.

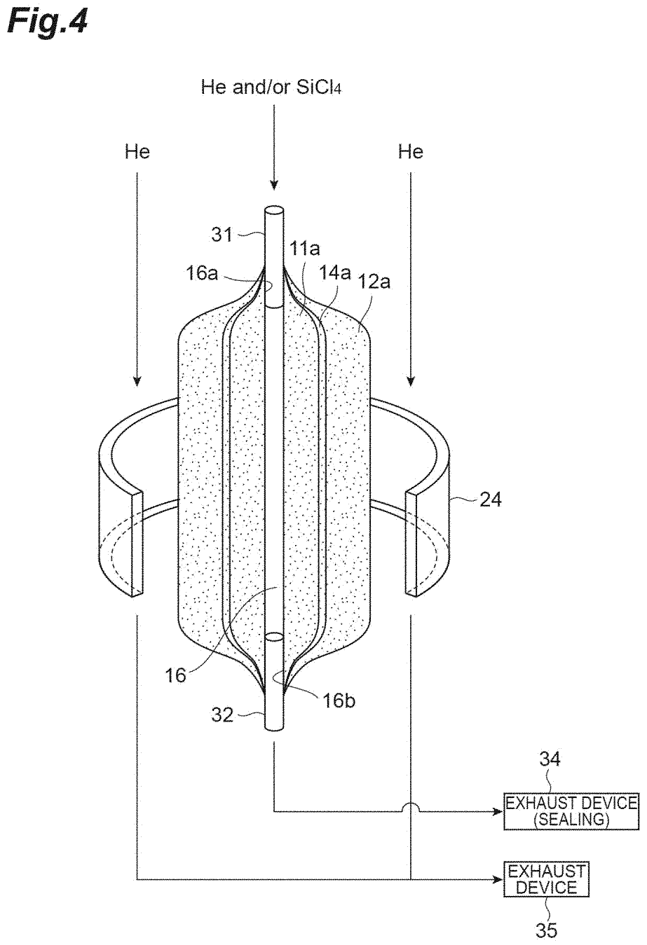

Next, a first embodiment of the gas introduction step performed in the dehydration step and the sintering step shown in FIG. 2B will be described in more detail with reference to FIGS. 3 and 4. FIG. 3 is a schematic diagram showing the first embodiment of the dehydration step in the method for manufacturing an optical fiber preform. FIG. 4 is a schematic diagram showing the first embodiment of the sintering step in the method for manufacturing an optical fiber preform. In FIGS. 3 and 4, the sintering furnace 23 in which the glass fine particle deposit 10a is accommodated is omitted. In the gas introduction step, the first gas is introduced in the inside of the hollow portion 16 of the glass fine particle deposit 10a, and the second gas is introduced to the outside of the glass fine particle deposit 10a. The first gas introduced into the inside is a gas containing halogen such as chlorine, and the gases are introduced so that the first partial pressure of the first gas and the second partial pressure of the second gas introduced to the outside are different.

More specifically, as shown in FIG. 3, in the dehydration step, a glass pipe 31 constituting a part of the gas introduction apparatus is airtightly fitted into one end 16a of the hollow portion 16 passing through the glass fine particle deposit 10a. From a main body (not shown) of the gas introduction apparatus, the first gas is introduced into the hollow portion 16 via the glass pipe 31. On the other hand, a glass pipe 32 connected to the exhaust device 34 via an adjustment mechanism 33 is airtightly fitted into the other end 16b of the hollow portion 16. The adjustment mechanism 33 is a mechanism for adjusting a passing amount of gas such as a valve and adjusts the partial pressure of the first gas in the hollow portion 16 by adjusting an exhaust rate of the first gas introduced through the glass pipe 31. The adjustment mechanism 33 can adjust the gas to be discharged while the partial pressure of the first gas in the hollow portion 16 is kept at, for example, 1 atm or more. The barrier layer 14a having a high volume density is provided between the core portion 11a and the cladding portion 12a of the glass fine particle deposit 10a to extend in the circumferential direction and the axial direction, the first gas in the hollow portion 16 does not leak to the outside, and the partial pressure in the hollow portion 16 is maintained at a predetermined value. As described above, the barrier layer 14a has a thickness of, for example, 10 μm or more and 1000 μm or less, and has a volume density of, for example, 1.5 g/cm³ or more and 2.2 g/cm³ or less.

In the dehydration step shown in FIG. 3, after the above-described setting, a temperature inside the furnace is raised to, for example, 1200° C. by the heater 24. When an atmospheric temperature of the glass fine particle deposit 10a reaches 1200° C., helium (He) and silicon tetrachloride (SiCl₄) are introduced as the first gas from the main body of the gas introduction apparatus into the hollow portion 16 of the glass fine particle deposit 10a via the glass pipe 31. As the first gas to be introduced into the glass fine particle deposit 10a, helium and silicon tetrachloride may be introduced at the same time, silicon tetrachloride and helium may be introduced in sequence or alternately, or only silicon tetrachloride may be introduced. The concentration of chlorine gas (the concentration of halogen) at the time of introducing the first gas may be, for example, 10% by volume or more and 100% by volume or less. Further, as the first gas to be introduced into the glass fine particle deposit 10a, another chlorine-based gas (Cl₂ or GeCl₄) may be used instead of the above-described silicon tetrachloride. When the first gas is introduced in the dehydration step, the atmospheric temperature of the glass fine particle deposit 10a may be, for example, 1000° C. or higher and 1300° C. or lower.

Meanwhile, silicon tetrachloride or chlorine gas (Cl₂) is introduced as the second gas from the main body of the gas introduction apparatus to the outside of the glass fine particle deposit 10a. However, since control of the partial pressure is not performed on the outer periphery of the glass fine particle deposit 10a as in the hollow portion 16, the second gas is introduced at a partial pressure lower than the partial pressure of the first gas and is discharged from the exhaust device 35.

According to such a gas introduction method, since silicon tetrachloride or the like introduced into the hollow portion 16 of the glass fine particle deposit 10a can be introduced under a high partial pressure, for example, a partial pressure of 1 atm or more and 10 atm or less, chlorine can be added to the core portion 11a at a high concentration. Further, the OH group in the glass fine particle deposit 10a is efficiently removed by the gas (silicon tetrachloride) introduced to the outer periphery of the glass fine particle deposit 10a. However, since the partial pressure of the gas introduced to the outer periphery of the glass fine particle deposit 10a is lower than the partial pressure of the first gas introduced into the hollow portion 16, chlorine is not positively added to the cladding portion 12a.

Further, in the sintering step, as shown in FIG. 4, high-pressure addition of chlorine is performed in the same manner as in the dehydration step. In this step, the heat treatment and the gas introduction step substantially similar to the above-described dehydration step are performed, but there is a difference in that the heating temperature is higher than that in the dehydration step and the gas introduced to the outer periphery of the glass fine particle deposit 10a is changed to helium (He) gas. In the sintering step, the heater 24 raises the temperature inside the furnace to, for example, 1500° C. The atmospheric temperature of the glass fine particle deposit 10a when the first gas is introduced in the sintering step may be, for example, 1300° C. or higher and 1600° C. or lower. Further, in the sintering step, the exhaust device 34 is sealed without using the adjustment mechanism 33, and at the time of the high-pressure addition of chlorine, the discharge of the first gas is temporarily stopped to increase the partial pressure in the hollow portion 16. Other configurations and methods are the same, and it is possible to add chlorine having a high concentration to the core portion 11a of the glass fine particle deposit 10a even in the sintering step.

In the above, although an example in which chlorine is added to the core portion 11a at a high concentration in both the dehydration step and the sintering step has been described, in either the dehydration step or the sintering step, the chlorine addition step described above may be performed, or the chlorine addition step may be performed separately from the dehydration step and the sintering step. The same applies to the following second embodiment.

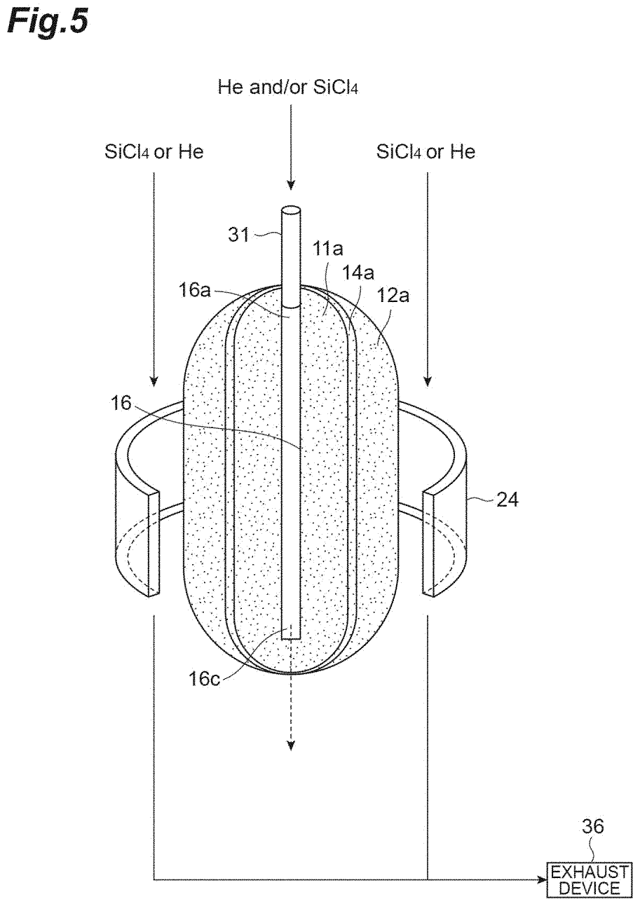

Next, a second embodiment of the high-pressure addition method of chlorine performed in the dehydration step and the sintering step will be described with reference to FIG. 5. In the step according to the second embodiment, the fact that the first gas is introduced into the inside of the hollow portion 16 of the glass fine particle deposit 10a and the second gas is introduced to the outside of the glass fine particle deposit 10a, and the fact that the first gas introduced into the inside is the gas containing halogen such as chlorine and the gases are introduced so that the first partial pressure of the first gas and the second partial pressure of the second gas are different from each other (for example, the first partial pressure is higher than the second partial pressure) are the same as in the first embodiment.

In the high-pressure addition method of chlorine according to the second embodiment, the other end 16c of the hollow portion 16 of the glass fine particle deposit 10a has a shape that is closed in advance, and the barrier layer 14a that extends to a lower end makes it difficult for the first gas introduced into the hollow portion 16 to be discharged to the outside by the exhaust device 36 (the first gas tends to remain inside). However, the barrier layer 14a does not completely prevent the first gas introduced into the hollow portion 16 (refer to the dotted line arrow in FIG. 5) from passing therethrough and is adjusted so that the partial pressure in the hollow portion 16 is 1 atm or more and 10 atm or less. That is, the amount of the first gas that permeates per hour and the partial pressure in the hollow portion 16 can be adjusted by adjusting the thickness and volume density of the barrier layer 14a. The barrier layer 14a may be configured such that, for example, a lower end portion thereof has a lower volume density or a thinner thickness than that of a portion extending in the axial direction.

In the high-pressure addition method of chlorine according to the second embodiment, since the other end 16c of the hollow portion 16 is closed, the partial pressure in the hollow portion 16 can be easily maintained at a predetermined value (for example, 1 atm) or more without the adjustment mechanism 33 or the like. However, although a certain amount of the first gas escapes to the outside through the barrier layer 14a (refer to an arrow shown by a dotted line in FIG. 5), the partial pressure in the hollow portion 16 can be easily maintained at a predetermined value. In the method according to the second embodiment, silicon tetrachloride is introduced to the outer periphery of the glass fine particle deposit 10a in the dehydration step, but in the sintering step, helium is introduced to the outer periphery of the glass fine particle deposit 10a, as in the first embodiment.

As described above, in the method for manufacturing an optical fiber preform according to the embodiment, the first gas is introduced into the inside of the hollow portion 16 of the glass fine particle deposit 10a and the second gas is introduced to the outside of the glass fine particle deposit 10a in the gas introduction step of the dehydration step or the sintering step, and at least one of the first gas and the second gas is a gas containing halogen (for example, a chlorine-based gas). In this gas introduction step, the gas containing halogen is introduced so that the first partial pressure of the first gas and the second partial pressure of the second gas are different from each other. Accordingly, the concentration of halogen added to the optical fiber preform can be easily increased by a simple method, such as by increasing the partial pressure of the introduced gas to a region in which halogen such as chlorine is desired to be added, as compared to a case in which the partial pressure of the entire introduced gas is increased.

In the method for manufacturing an optical fiber preform according to the above-described embodiment, the first gas is a gas containing halogen (for example, chlorine), the first partial pressure of the first gas is higher than the second partial pressure of the second gas, and the first partial pressure of the first gas is 1 atm or more. Since halogen (for example, chlorine) is added by increasing only the partial pressure of the first gas introduced into the inside of the hollow portion 16 of the glass fine particle deposit 10a, the concentration of halogen added to the optical fiber preform can be easily increased by a simple method.

In the method for manufacturing an optical fiber preform according to the above-described embodiment, the gas containing halogen can be silicon tetrachloride (SiCl₄). When the gas containing halogen is silicon tetrachloride, it is possible to easily increase the concentration of chlorine added to the porous glass preform (for example, the core portion 11), as compared with a case in which chlorine gas (Cl₂) is introduced. Thus, for example, the amount of germanium (Ge) used to increase the refractive index of the core portion 11 can be reduced, Rayleigh scattering can be reduced, and thus the transmission loss when it is drawn into an optical fiber can be reduced. It is possible to reduce costs by reducing the amount of germanium used.

In the method for manufacturing the optical fiber preform according to the above-described embodiment, the gas containing halogen is introduced into at least one of the inside and the outside of the glass fine particle deposit 10a in an environment in which the atmospheric temperature of the glass fine particle deposit 10a is 1000° C. or higher and 1600° C. or lower in the gas introduction step. When the atmospheric temperature of the glass fine particle deposit 10a is lower than 1000° C., it is difficult to efficiently add halogen to the glass fine particle deposit 10a, but it becomes possible to efficiently add halogen by setting the temperature to 1000° C. or higher. When the atmospheric temperature of the glass fine particle deposit 10a exceeds 1600° C., glass viscosity of the glass fine particle deposit tends to decrease, and the glass fine particle deposit 10a may be vitrified or a shape thereof may be deformed. Accordingly, it is possible to efficiently increase the concentration of halogen in a predetermined region by introducing the gas containing halogen in an environment in which the atmospheric temperature of the glass fine particle deposit is 1000° C. or higher and 1600° C. or lower.

In the method for manufacturing an optical fiber preform according to the above-described embodiment, the glass fine particle deposit 10a is prepared so that the average volume density is 0.1 g/cm³ or more and 1.0 g/cm³ or less, and a circumferential barrier layer 14 having a thickness of 10 μm or more and 1000 μm or less and a volume density of 1.5 g/cm³ or more and 2.2 g/cm³ or less is provided at an arbitrary position on the glass fine particle deposit 10a in the radial direction, in the glass fine particle deposition step. By providing the barrier layer having a high volume density, the first partial pressure of the first gas on the inside of the barrier layer in the radial direction and the second partial pressure of the second gas on the outside thereof in the radial direction can be easily different from each other. For example, it is possible to increase the partial pressure of the first gas introduced into the inside of the hollow portion 16 of the glass fine particle deposit and thus to introduce the gas containing halogen. When the average volume density of the glass fine particle deposit is 0.1 g/cm³ or more, occurrence of soot cracks in the glass fine particle deposit can be easily prevented, and also, when the average volume density of the glass fine particle deposit is 1.0 g/cm³ or less, the dehydration treatment in the dehydration step is easily performed.

In the method for manufacturing an optical fiber preform according to the above-described embodiment, the concentration of halogen in the gas containing halogen may be 10% by volume or more and 100% by volume or less. In this case, the concentration of halogen added to the glass fine particle deposit 10a (for example, the core portion 11) can be efficiently increased.

In the method for manufacturing an optical fiber preform according to the above-described embodiment, the partial pressure of the gas containing halogen is 10 atm or less. Accordingly, a large-scale device for introducing a gas becomes unnecessary, and the concentration of halogen added to the optical fiber preform can be easily increased by a simpler method.

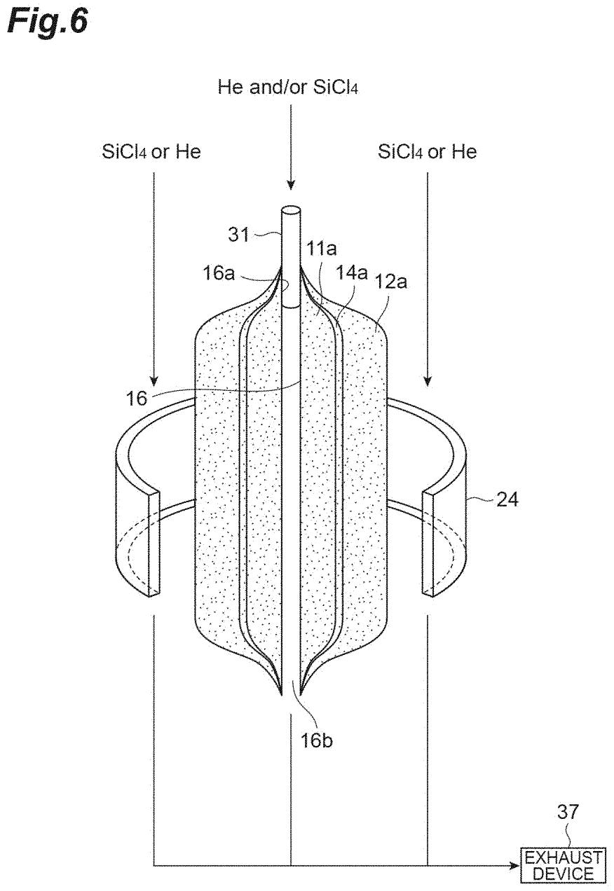

Here, experimental results by simulation regarding the above-described high-concentration chlorine addition method will be described. This simulation compares a case in which an apparatus configuration according to the second embodiment shown in FIG. 5 is used (Example) and a case in which a conventional apparatus configuration shown in FIG. 6 is used (Comparative example), and this is a comparison of a difference in the partial pressure of the first gas introduced into the hollow portion 16 (the partial pressure of SiCl₄), the concentration of chlorine added to the core portion 11, the refractive index difference between the core and the cladding, and the amount of addition of germanium (Ge) that can be reduced as the concentration of chlorine increases. The heating temperature (the temperature when chlorine is doped) is set to 1100° C. In Table 1, Experimental example 1 and Experimental example 2 are comparative examples using the conventional apparatus configuration shown in FIG. 6, and Experimental example 3 to Example 7 are examples using the apparatus configuration (the second embodiment) shown in FIG. 5. Even in a case of manufacturing with the apparatus configuration of the first embodiment, the concentration of chlorine could be increased and the effect of reducing the amount of germanium added could be obtained as in the case of manufacturing in the second embodiment.

TABLE 1

| | Partial | | Difference in refractive index | | | Addition |
|---|---|---|---|---|---|---|
| | pressure | Concentration | between core and cladding [%] | | | amount |
| | of SiCl₄ | of chlorine | | Contribution | Contribution | of Ge |
| | [atm] | [wt %] | Whole | of Ge | of chlorine | [%] |
| Experimental | 0.2 | 0.8 | 0.440 | 0.360 | 0.080 | 100 |
| example 1 | | | | | | |
| Experimental | 0.5 | 1.05 | 0.440 | 0.335 | 0.105 | 93 |
| example 2 | | | | | | |
| Experimental | 1 | 1.2 | 0.440 | 0.320 | 0.120 | 89 |
| example 3 | | | | | | |
| Experimental | 2 | 1.47 | 0.440 | 0.293 | 0.147 | 81 |
| example 4 | | | | | | |
| Experimental | 4 | 1.75 | 0.440 | 0.265 | 0.175 | 74 |
| example 5 | | | | | | |
| Experimental | 6 | 1.95 | 0.440 | 0.245 | 0.195 | 68 |
| example 6 | | | | | | |
| Experimental | 8 | 2.13 | 0.440 | 0.227 | 0.213 | 63 |
| example 7 | | | | | | |

In the conventional apparatus shown in FIG. 6, a device for adjusting the partial pressure is not mounted on the other end 16b of the hollow portion 16 of the glass fine particle deposit 10a, and the partial pressure of the first gas introduced into the inside of the glass fine particle deposit 10a and the partial pressure of the second gas introduced to the outside thereof are the same, and the gases are collectively discharged by the exhaust device 37. In Experimental examples 1 and 2 using the conventional apparatus, since the partial pressure adjustment is not performed, the partial pressure of the first gas introduced into the hollow portion 16 of the glass fine particle deposit 10a is about the same as the partial pressure of the second gas introduced to the outside of the glass fine particle deposit 10a (0.2 atm or 0.5 atm). Thus, as shown in Table 1, the concentration of chlorine of the core portion 11 in the manufactured optical fiber preform 10 is 0.8% by weight or 1.05% by weight. Thus, when the difference in the refractive index between the core portion 11 and the clad portion 12 is set to, for example, 0.440%, it is necessary to increase the contribution of germanium, and thus it is difficult to reduce the concentration of germanium to be added. The above-described difference in the refractive index of 0.440% is a value obtained by adding 0.400% which is a difference in a specific refractive index of the core portion 11 and 0.04% which is a difference in a specific refractive index of the cladding portion 12. The difference in the specific refractive index used here indicates a difference from pure silica glass. Further, in the experimental examples shown in Table 1, the addition amount of germanium required in Experimental example 1 in which the partial pressure of silicon tetrachloride is 0.2 atm is set to 100%, and the amount of added germanium required in other experimental examples is calculated based thereon.

On the other hand, as shown in Experimental examples 3 to 7 in Table 1, the apparatus shown in FIG. 5 can set the partial pressure of the first gas introduced into the hollow portion 16 of the glass fine particle deposit 10a to 1 atm or more. Thus, the concentration of chlorine of the core portion 11 in the manufactured optical fiber preform 10 can be increased to 1.2% by weight, 1.47% by weight, 1.75% by weight, 1.95% by weight, and 2.13% by weight, which are higher than those of Experimental examples 1 and 2. That is, more chlorine can be added to the core portion 11. Thus, when the difference in the refractive index between the core portion 11 and the cladding portion 12 is set to 0.440, the contribution of germanium can be reduced, and the concentration of germanium to be added can be reduced. For example, Experimental example 4 can reduce the amount of germanium required by about 20% as compared with Experimental example 1.

Next, experimental results by simulation in which the same method as that in Table 1 is performed except that the heating temperature (the temperature when chlorine is doped) is changed to 1200° C. will be described with reference to Table 2. In Table 2, Experimental examples 11 and 12 are comparative examples using the conventional apparatus configuration shown in FIG. 6, and Experimental examples 13 to 17 are examples using the apparatus configuration shown in FIG. 5.

TABLE 2

| | Partial | | Difference in refractive index | | | Addition |
|---|---|---|---|---|---|---|
| | pressure | Concentration | between core and cladding [%] | | | amount |
| | of SiCl₄ | of chlorine | | Contribution | Contribution | of Ge |
| | [atm] | [wt %] | Whole | of Ge | of chlorine | [%] |
| Experimental | 0.2 | 1 | 0.440 | 0.340 | 0.100 | 100 |
| example 11 | | | | | | |
| Experimental | 0.5 | 1.35 | 0.440 | 0.305 | 0.135 | 90 |
| example 12 | | | | | | |
| Experimental | 1 | 1.65 | 0.440 | 0.275 | 0.165 | 81 |
| example 13 | | | | | | |
| Experimental | 2 | 1.95 | 0.440 | 0.245 | 0.195 | 72 |
| example 14 | | | | | | |
| Experimental | 4 | 2.35 | 0.440 | 0.205 | 0.235 | 60 |
| example 15 | | | | | | |
| Experimental | 6 | 2.55 | 0.440 | 0.185 | 0.255 | 54 |
| example 16 | | | | | | |
| Experimental | 8 | 2.78 | 0.440 | 0.162 | 0.278 | 48 |
| example 17 | | | | | | |

In Experimental examples 11 and 12 using the conventional apparatus shown in FIG. 6, since the partial pressure adjustment is not performed, the partial pressure of the first gas introduced into the hollow portion 16 of the glass fine particle deposit 10a is about the same as the partial pressure of the second gas introduced to the outside of the glass fine particle deposit 10a (0.2 atm or 0.5 atm). Thus, as shown in Table 2, the concentration of chlorine of the core portion 11 in the manufactured optical fiber preform 10 is 1% by weight or 1.35% by weight. Thus, when the difference in refractive index between the core portion 11 and the cladding portion 12 is set to, for example, 0.440%, it is necessary to increase the contribution of germanium, and it is difficult to reduce the concentration of germanium to be added. In the experimental examples shown in Table 2, the amount of germanium added in Experimental example 11 in which the partial pressure of silicon tetrachloride is 0.2 atm is set to 100%, and the amount of germanium added in the other experimental examples is calculated based thereon.

On the other hand, as shown in Experimental examples 13 to 17 in Table 2, the apparatus shown in FIG. 5 can set the partial pressure of the first gas introduced into the hollow portion 16 of the glass fine particle deposit 10a to 1 atm or more. Thus, the concentration of chlorine of the core portion 11 of the manufactured optical fiber preform 10 is 1.65% by weight, 1.95% by weight, 2.35% by weight, 2.55% by weight, 2.78% by weight, which can be higher than those of Experimental examples 11 and 12. That is, more chlorine can be added to the core portion 11. Thus, when the difference in the refractive index between the core portion 11 and the cladding portion 12 is set to 0.440, the contribution of germanium can be reduced, and the concentration of germanium to be added can be reduced. For example, in Experimental example 15, the amount of germanium required can be reduced by about 40% as compared with Experimental example 11.

Next, experimental results by simulation using the same method as in Table 1 and Table 2 except that the heating temperature (the temperature when chlorine is doped) is changed to 1300° C. will be described with reference to Table 3. In Table 3, Experimental examples 21 and 22 are comparative examples using the conventional apparatus configuration shown in FIG. 6, and Experimental examples 23 to 27 are examples using the apparatus configuration shown in FIG. 5.

TABLE 3

| | Partial | | Difference in refractive index | | | Addition |
|---|---|---|---|---|---|---|
| | pressure | Concentration | between core and clad [%] | | | amount |
| | of SiCl₄ | of chlorine | | Contribution | Contribution | of Ge |
| | [atm] | [wt %] | Whole | of Ge | of chlorine | [%] |
| Experimental | 0.2 | 1.2 | 0.440 | 0.320 | 0.120 | 100 |
| example 21 | | | | | | |
| Experimental | 0.5 | 1.7 | 0.440 | 0.270 | 0.170 | 84 |
| example 22 | | | | | | |
| Experimental | 1 | 2.05 | 0.440 | 0.235 | 0.205 | 73 |
| example 23 | | | | | | |
| Experimental | 2 | 2.45 | 0.440 | 0.195 | 0.245 | 61 |
| example 24 | | | | | | |
| Experimental | 4 | 2.9 | 0.440 | 0.150 | 0.290 | 47 |
| example 25 | | | | | | |
| Experimental | 6 | 3.25 | 0.440 | 0.115 | 0.325 | 36 |
| example 26 | | | | | | |
| Experimental | 8 | 3.5 | 0.440 | 0.090 | 0.350 | 28 |
| example 27 | | | | | | |

In Experimental examples 21 and 22 using the conventional apparatus shown in FIG. 6, since the partial pressure adjustment is not performed, the partial pressure of the first gas introduced into the hollow portion 16 of the glass fine particle deposit 10a is about the same as the partial pressure of the second gas introduced to the outside of the glass fine particle deposit 10a (0.2 atm or 0.5 atm). Thus, as shown in Table 3, the concentration of chlorine of the core portion 11 in the manufactured optical fiber preform 10 is 1.2% by weight or 1.7% by weight. Thus, when the difference in the refractive index between the core portion 11 and the cladding portion 12 is set to, for example, 0.440%, it is necessary to increase the contribution of germanium, and it is difficult to reduce the concentration of germanium to be added. Further, in Experimental examples shown in Table 3, the amount of germanium added in Experimental example 21 in which the partial pressure of silicon tetrachloride is 0.2 atm is set to 100%, and the amount of germanium added in other Experimental examples is calculated based thereon.

On the other hand, as shown in Experimental examples 23 to 27 in Table 3, the apparatus shown in FIG. 5 can set the partial pressure of the first gas introduced into the hollow portion 16 of the glass fine particle deposit 10a to 1 atm or more. Thus, the concentration of chlorine of the core portion 11 in the manufactured optical fiber preform 10 is 2.05% by weight, 2.45% by weight, 2.9% by weight, 3.25% by weight, and 3.5% by weight, which can be higher than those of Experimental examples 21 and 22. That is, more chlorine can be added to the core portion 11. Thus, when the difference in the refractive index between the core portion 11 and the cladding portion 12 is set to 0.440, the contribution of germanium can be reduced, and the concentration of germanium to be added can be reduced. For example, in Experimental example 27, the amount of germanium required can be reduced by about 70% as compared with Experimental example 21.

From the above-described experimental examples, in the gas introduction step, high-concentration addition of chlorine or the like to the core portion 11 of the glass fine particle deposit 10a can be easily performed with a simple method by making the first partial pressure of the first gas introduced into the inside of the glass fine particle deposit and the second partial pressure of the second gas introduced to the outside of the glass fine particle deposit different from each other, more specifically, increasing the first partial pressure of the first gas more than the second partial pressure of the second gas and introducing the gas containing halogen (chlorine, or the like).

Although the embodiments of the present disclosure have been described in detail above, the present invention is not limited to the above-described embodiments and can be applied to various embodiments. For example, in the above-described embodiment, although the method in which the partial pressure of the first gas introduced into the hollow portion 16 of the glass fine particle deposit 10a is increased to increase the concentration of chlorine or the like added to the core portion 11 has been described, the partial pressure of the second gas introduced to the outside of the glass fine particle deposit 10a may be made higher than the partial pressure of the first gas.

What is claimed is:

1. A method for manufacturing an optical fiber preform, comprising:
a glass fine particle deposition step of generating glass fine particles from a glass raw material gas in a flame obtained by burning a flammable gas supplied to a burner and depositing the glass fine particles to produce a hollow porous glass preform; and
a gas introduction step of introducing a first gas into an inside of a hollow of the porous glass preform and introducing a second gas to an outside of the porous glass preform,
wherein at least one of the first gas and the second gas is a gas containing halogen, and
wherein, in the gas introduction step, the gas containing halogen is introduced so that a first partial pressure of the first gas and a second partial pressure of the second gas are different from each other.

2. The method for manufacturing an optical fiber preform according to claim 1, wherein the first gas is the gas containing halogen, and the first partial pressure of the first gas is higher than the second partial pressure of the second gas.

3. The method for manufacturing an optical fiber preform according to claim 1, wherein the first gas is the gas containing halogen, and the first partial pressure of the first gas is 1 atm or more.

4. The method for manufacturing an optical fiber preform according to claim 1, wherein the gas containing halogen is silicon tetrachloride (SiCl₄).

5. The method for manufacturing an optical fiber preform according to claim 1, wherein, in the gas introduction step, the gas containing halogen is introduced into at least one of the inside and the outside of the porous glass preform in an environment in which an atmospheric temperature of the porous glass preform is 1000° C. or higher and 1600° C. or lower.

6. The method for manufacturing an optical fiber preform according to claim 1, wherein, in the glass fine particle deposition step, the porous glass preform is produced so that an average volume density is 0.1 g/cm³ or more and 1.0 g/cm³ or less, and a circumferential barrier layer having a thickness of 10 μm or more and 1000 μm or less and a volume density of 1.5 g/cm³ or more and 2.2 g/cm³ or less is provided at an arbitrary position on the porous glass preform in a radial direction.

7. The method for manufacturing an optical fiber preform according to claim 1, wherein a concentration of halogen in the gas containing halogen is 10% by volume or more and 100% by volume or less.

8. The method for manufacturing an optical fiber preform according to claim 1, wherein the partial pressure of the gas containing halogen is 10 atm or less.

9. An apparatus for manufacturing an optical fiber preform, comprising:
a furnace tube configured to accommodate a hollow porous glass preform;
a heater that heats the porous glass preform; and
a gas introduction device configured to introduce a first gas into an inside of a hollow of the porous glass preform and to introduce a second gas to an outside of the porous glass preform,
wherein at least one of the first gas and the second gas is a gas containing halogen, and
wherein the gas introduction device introduces the gas containing halogen into the furnace tube so that a first partial pressure of the first gas and a second partial pressure of the second gas are different from each other.

10. The apparatus for manufacturing an optical fiber preform according to claim 9, comprising:
an exhaust device that discharges the first gas introduced into an inside of the porous glass preform, and
an adjustment mechanism that adjusts the partial pressure of the first gas introduced into the inside of the porous glass preform.

11. The apparatus for manufacturing an optical fiber preform according to claim 9,
wherein the gas introduction device introduces the gas containing halogen as the first gas into the inside of the porous glass preform, and the first partial pressure of the first gas is higher than the second partial pressure of the second gas.

12. The apparatus for manufacturing an optical fiber preform according to claim 9,
wherein the gas containing halogen is silicon tetrachloride (SiCl₄).
